(19) United States
(12) Patent Application Publication
(10) Pub. No.: US 2022/0247110 A1
(43) Pub. Date: Aug. 4, 2022

(54) CONNECTOR

(71) Applicant: XIAMEN GHGM INDUSTRIAL TRADE CO., LTD, Xiamen (CN)

(72) Inventor: Bingshui Chen, Xiamen (CN)

(21) Appl. No.: 17/718,287

(22) Filed: Apr. 11, 2022

Related U.S. Application Data
(63) Continuation of application No. PCT/CN2019/122846, filed on Dec. 4, 2019.

(30) Foreign Application Priority Data
Oct. 14, 2019 (CN) 201910973124.0

(51) Int. Cl. H01R 13/28; H01R 12/73; H01R 12/72; H01R 4/48

(52) U.S. Cl. CPC H01R 13/28; H01R 4/48; H01R 12/722; H01R 12/732

(57) ABSTRACT

A connector includes a male end and a female end. Specifically, the male end includes a male housing and first lap joints. The first lap joints are disposed on the male housing and are soldered to a first PCB. First lap joint portions, extending forward and having elasticity, are disposed on the first lap joints. The first lap joint portions are in a geometry shape of wave-shaped thin plate. The female end includes a female housing and second lap joints. The female housing is matched with the male shell. The second lap joints are disposed on the female shell, and are soldered to the second PCB or electrically connected to the conductive wires. Second lap joint portions, extending forward and having elasticity, are disposed on the second lap joints.

### TECHNICAL FIELD

The present disclosure relates to a technical field of connectors, and in particular to a lap joint connector.

### BACKGROUND

A connector is a device configured to detachably connect wire to wire, printed circuit board (PCB) to PCB, and PCB to wire.

At present, most connectors have a male end and a female end where the male end and female are in plug-in connection. Further, the male end is generally electrically connected with the female end through a conductive clip and a plug rod. In prior art, due to a fact that the conductive clip needs to be effectively and reliably matched with the plug rod, the conductive clip must have a sufficient height to achieve resettable matching with the plug rod, which is very difficult to reduce thickness of the connector. In addition, a matching manner between the conductive clip and the plug rod causes a contact surface between the conductive clip and the plug rod to be linear, and an area of the contact surface is too small, which is easy to heat and is difficult to meet passage of high current. In view of above, the applicant provides the present disclosure after studying the prior art.

### SUMMARY

The present disclosure provides a lap joint connector, which aims to solve a problem that connectors in prior art are difficult to be thin.

The present disclosure provides the connector, configured to electrically connect a first printed circuit board (PCB) with a second PCB, or configured to electrically connect the first PCB with conductive wires, including a male end and a female end. The male end includes a male housing and a pair of first lap joints. The first lap joints are disposed on the male housing and are soldered to the first PCB. A pair of first lap joint portions, extending forward and having elasticity, are disposed on the first lap joints. The first lap joint portions are in a geometry shape of wave-shaped thin plate.

The female end includes a female housing and a pair of second lap joints. The female housing is matched with the male housing. The second lap joints are disposed on the female housing, and the second lap joints are soldered to the second PCB or are electrically connected to the conductive wires. A pair of second lap joint portions, extending forward and having elasticity, are disposed on the second lap joints. The second lap joint portions are in a geometry shape of wave-shaped thin plate, and the second lap joint portions are matched with the first lap joint portions.

The male housing is disposed on the female housing, and the male housing drives the first lap joint portions to be overlapped and attached to the second lap joint portions, so that the first PCB is electrically connected to the second PCB or the conductive wires.

Furthermore, the first lap joint portions and the second lap joint portions are both in a geometry shape of S-shaped thin plate, and ends of the first lap joint portions face opposite to ends of the second lap joint portions.

Furthermore, the male end includes the pair of the first lap joints where one of the first lap joints is directly disposed on the male housing and another one of the first lap joints is inverted on the male housing, and the female end includes the pair of the second lap joints where one of the second lap joints is directly disposed on female housing and another one of the second lamp joints is inverted on the female housing.

Furthermore, the conductive wires are detachably plugged into the second lap joints.

Furthermore, limiting protrusions are disposed on the second lap joints, and the limiting protrusions extend downward and are clamped to the female housing.

Furthermore, the second lap joints are soldered to the second PCB, and the first lap joints and the second lap joints are same assemblies.

Furthermore, first clamping teeth protruding outward are disposed on two sides of each of the first lap joints.

Furthermore, the second lap joints are soldered to the second PCB, and both the first lap joints and the second lap joints are horizontally or vertically disposed on the first PCB and the second PCB.

Through adopting the above technical solution, the present disclosure achieves following technical effects:

The present disclosure provides the connector to be thin, where the connector further has a reliable contact surface and realizes passage of high current. Specifically, in a process of the male end is plugged into the female end, a side surface of each of the first lap joint portions of the first lap joints abuts against a side surface of each of the second lap joint portions of the second lap joints. Then, the side surface of each of the wave-shaped first lap joint portions is squeezed with the side surface of each of the wave-shaped second lap joint portions, so that the first lap joint portions and the second lap joint portions are elastically deformed in two opposite directions. Finally, the wave-shaped first lap joint portions and the wave-shaped second lap joint portions are overlapped and attached together.

Due to a fact that the first lap joint portions and the second lap joint portions are in the geometry shape of thin plate, and the first lap joint portions and the second lap joint portions are overlapped and attached together, both the male end and the female end are made into a thin flat shape to meet installation of the first lap joints and the second lap joints. In addition, the wave-shaped first lap joint portions and the wave-shaped second lap joint portions are attached together through staggered squeezing and lap joints, which not only allows the first lap joint portions and the second lap joint portions to be tightly attached to achieve electrical connection, but also allows the first lap joint portions and the second lap joint portions to be in surface-to-surface contact. Compared with the prior art, the present disclosure greatly increases a contact area between the male end and the female end, and reduces heat generated when the current passes through, so as to meet the passage of the high current.

### BRIEF DESCRIPTION OF DRAWINGS

In order to more clearly illustrate technical solution of embodiments of the present disclosure, drawings required in the embodiments are briefly introduced below. It should be understood that the following drawings illustrate only certain embodiments of the present disclosure, and are therefore not to be considered as limiting a scope. For a person of ordinary skill in art, other related drawings may be obtained according to the drawings without creative efforts.

FIG. 1 is a structural schematic diagram of a shaft side of a connector according to a first embodiment of the present disclosure.

FIG. 2 is an assembly schematic diagram of a male end and a female end according to the first embodiment of the present disclosure.

FIG. 3 is an exploded schematic diagram of the connector according to the first embodiment of the present disclosure.

FIG. 4 is a cross-sectional structural schematic diagram of the connector according to the first embodiment of the present disclosure.

FIG. 5 is a structural schematic diagram of the shaft side of the connector according to the first embodiment of the present disclosure (a male housing and a female housing are hidden).

FIG. 6 is a structural schematic diagram of a shaft side of a connector according to a second embodiment of the present disclosure.

FIG. 7 is an assembly schematic diagram of a male end and a female end according to the second embodiment of the present disclosure.

FIG. 8 is an exploded schematic diagram of the connector according to the second embodiment of the present disclosure.

FIG. 9 is a cross-sectional structural schematic diagram of the connector according to the second embodiment of the present disclosure.

FIG. 10 is a structural schematic diagram of the shaft side of the connector according to the second embodiment of the present disclosure (a male housing and a female housing are hidden).

FIG. 11 is an assembly schematic diagram of a male end and a female end according to a third embodiment of the present disclosure.

FIG. 12 is an exploded schematic diagram of the connector according to the third embodiment of the present disclosure.

FIG. 13 is an assembly schematic diagram of a male end and a female end according to a fourth embodiment of the present disclosure.

FIG. 14 is an exploded schematic diagram of the connector according to the fourth embodiment of the present disclosure.

Reference number in the drawings: 1. first PCB; 2. conductive wires; 3. second PCB; 4. male end; 5. female end; 6. first lap joints; 7. male shell; 8. female shell; 9. second lap joints; 10. first lap joint portions; 11. second lap joint portions; 12. first clamping teeth; 13. limiting protrusions; 14. second clamping teeth.

### DETAILED DESCRIPTION

In order to make objectives, technical solutions and advantages of embodiments of the present disclosure clearer, the technical solutions in the embodiments of the present disclosure are clearly and completely described below with reference to accompanying drawings in the embodiments of the present disclosure. Obviously, the described embodiments are part of the embodiments of the disclosure, and are not all of the embodiments. Therefore, following detailed description of the embodiments of the present disclosure provided in the drawings is not intended to limit a scope of the present disclosure, which is claimed, but is merely representative of the selected embodiments of the present disclosure. All other embodiments obtained by a person of ordinary skill in art based on the embodiments of the present disclosure without creative efforts shall fall within the protection scope of the present disclosure.

In the description of the present disclosure, it should be understood that orientation or positional relationship indicated through terms “center”, “longitudinal” “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc. is based on the orientation or positional relationship shown in the accompanying drawings, and is merely for convenience of describing the present disclosure and simplifying the description, rather than indicating or implying that an indicated device or an indicated element has to have a specific orientation, is constructed and operated in a specific orientation, which is therefore not to be construed as limiting the present disclosure.

In addition, the terms “first” and “second” are configured for descriptive purposes only and cannot be understood as indicating or implying relative importance or implicitly indicating a number of indicated technical features. Thus, the features defined with “first” and “second” explicitly or implicitly include one or more of the features. In the description of the present disclosure, “a plurality of” means two or more, unless specifically defined otherwise.

In the present disclosure, the terms such as “mounted”, “joined”, “connected”, “fixed”, etc. should be broadly understood, for example, may be fixed connections, detachable connections, or integrated; may be mechanically connected or electrically connected; may be directly connected or indirectly connected through an intermediate medium, and may be in communication between two elements or an interaction relationship between two elements. For the person of the ordinary skill in the art, specific meanings of the above terms in the present disclosure are understood according to specific situations.

In the present disclosure, unless expressly specified and defined otherwise, the first feature “on” or “below” the second feature may include the first feature and the second feature being in direct contact, and may further include that the first feature and the second feature are not in direct contact but are in contact through additional features therebetween. Moreover, the first feature “over”, “above”, and “upper” of the second feature indicates the first feature directly above and obliquely above the second feature, or simply indicates that a level height of the first feature is higher than the level height of the second feature. The first feature “beneath”, “below”, and “lower” of the second feature indicates the first feature directly below and obliquely below the second feature, or simply indicates that the level height of the first feature is less than the level height of the second feature.

The present disclosure is described in further detail below with reference to the accompanying drawings and the specific embodiments.

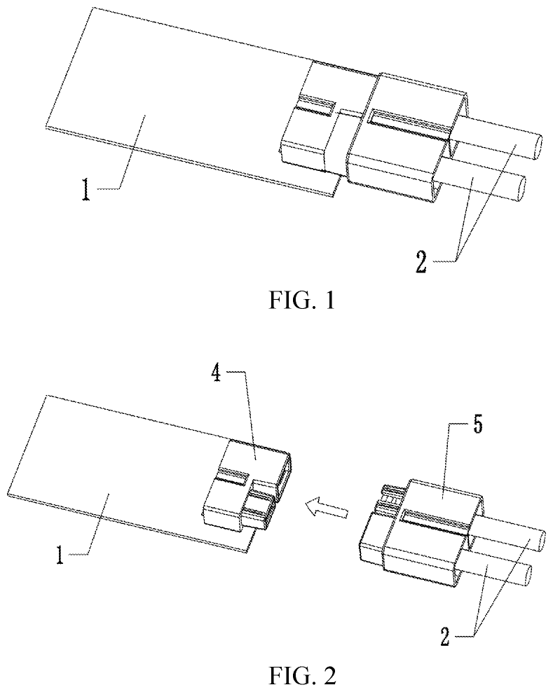

A first embodiment (as shown in FIGS. 1-5):

As shown in FIGS. 1-3, the first embodiment of the present disclosure provides a connector, configured to electrically connect a first PCB 1 with a second PCB 3, or configured to electrically connect the first PCB 1 with conductive wires 2, including a male end 4 and a female end 5.

The male end 4 includes a male housing 7 and a pair of first lap joints 6. The first lap joints 6 are disposed on the male housing 7 and are soldered to the first PCB 1. A pair of first lap joint portions 10, extending forward and having elasticity, are disposed on the first lap joints 6. The first lap joint portions 10 are in a geometry shape of wave-shaped thin plate.

The female end 5 includes a female housing 8 and a pair of second lap joints 9. The female housing 8 is matched with the male housing 7. The second lap joints 9 are disposed on the female housing 8, and the second lap joints 9 are soldered to the second PCB 3 or electrically connected to the conductive wires 2. A pair of second lap joint portions 11, extending forward and having elasticity, are disposed on the second lap joints 9. The second lap joint portions 11 are in a geometry shape of wave-shaped thin plate, and the second lap joint portions 11 is matched with the first lap joint portions 10.

The male housing 7 is disposed on the female housing 8, and the male housing 7 drives the first lap joint portions 10 to be overlapped and attached to the second lap joint portions 11, so that the first PCB 1 is electrically connected to the second PCB 3 or the conductive wires 2.

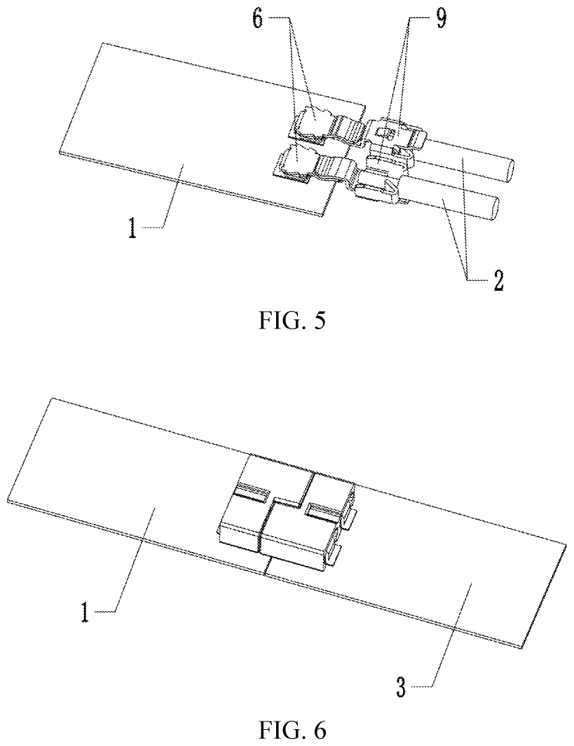

Specifically, as shown in FIGS. 4-5, when the male end 4 is plugged into the female end 5, in a process of the male end 4 is plugged into the female end 5, a side surface of each of the first lap joint portions 10 of the first lap joints 6 abuts against a side surface of each of the second lap joint portions 11 of the second lap joints 9. Then, the side surface of each of the wave-shaped first lap joint portions 10 is squeezed with the side surface of each of the wave-shaped second lap joint portions 11, so that the first lap joint portions 10 and the second lap joint portions 11 are elastically deformed in two opposite directions. Finally, the wave-shaped first lap joint portions 10 and the wave-shaped second lap joint portions 11 are overlapped and attached together.

Due to a fact that the first lap joint portions 10 and the second lap joint portions 11 are in the geometry shape of thin plate, and the first lap joint portions 10 and the second lap joint portions 11 are overlapped and attached together, both the male end 4 and the female end 5 are made into a thin flat shape to meet installation of the first lap joints 6 and the second lap joints 9. In addition, the wave-shaped first lap joint portions 10 and the wave-shaped second lap joint portions 11 are attached together through staggered squeezing and lap joints, which not only allows the first lap joint portions 10 and the second lap joint portions 11 to be tightly attached to achieve electrical connection, but also allows the first lap joint portions 10 and the second lap joint portions 11 to be in surface-to-surface contact. Compared with the prior art, the present disclosure greatly increases a contact area between the male end 4 and the female end 5, and reduces heat generated when the current passes through, so as to meet the passage of the high current.

In addition, it should be noted that the male end 4 and the female end 5 referred to by the present disclosure are only convenient to name the male end and the female end, but are not limited to shapes of the male end and the female end, and are not limited to the outer shapes of the male housing 7 and the female housing 8.

As shown in FIGS. 4-5, in the first embodiment, the first lap joint portions 10 and the second lap joint portions 11 are both in a geometry shape of S-shaped thin wave plate, and ends of the first lap joint portions 10 face opposite to ends of the second lap joint portions 11. Since the ends of the first lap joint portions 10 face opposite to the ends of the second lap joint portions 11, the first lap joint portions 10 and the second lap joint portions 11 are smoothly staggered relative to each other when the male end 4 is matched with the female end 5. Meanwhile, when the S-shaped first lap joint portions 10 and the S-shaped second lap joint portions 11 are in lap joint fit with each other, a locking function is achieved, and connection stability of the male end 4 and the female end 5 is enhanced. Certainly, in another embodiment, both the first lap joint portions 10 and the second lap joint portions 11 may be provided with a plurality of S-shaped curved surfaces, lap joint cases thereof are same as described above, and details are not described herein again.

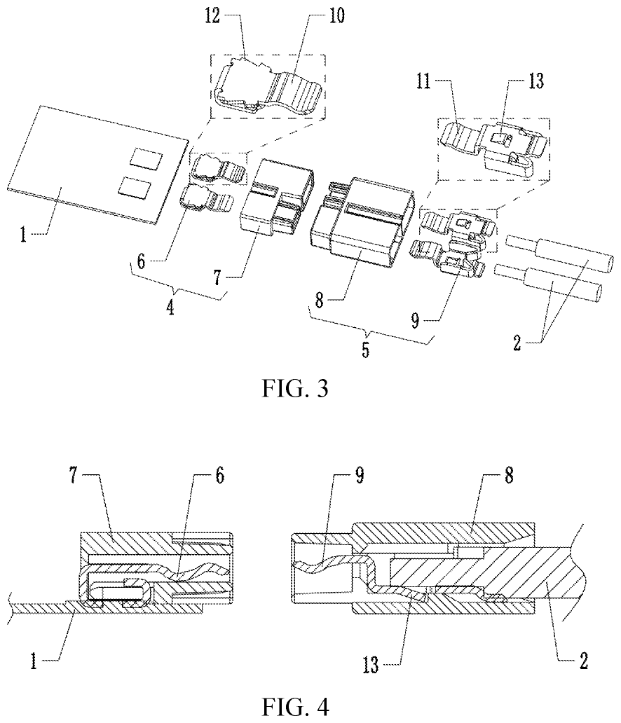

As shown in FIG. 2, FIG. 3, and FIG. 5, in the first embodiment, the male end 4 includes the pair of the first lap joints 6 where one of the first lap joints 6 is directly disposed on the male housing 7 and another one of the first lap joints 6 is inverted on the male housing 7, and the female end 5 includes the pair of the second lap joints 9 where one of the second lap joints 9 is directly disposed on the female housing 8 and another one of the second lap joints 9 is inverted on the female housing 8. In another embodiment, both the male end 4 and the female end 5 may be provided with different numbers of the first lap joints 6 and the second lap joints 9 according to actual requirements, and details are not described herein again.

As shown in FIG. 3, in the first embodiment, the conductive wires 2 are detachably plugged into the second lap joints 9. A plug-in structure of the conductive wires 2 and the second lap joints 9 belongs to the prior art in the art, and details are not described herein again.

As shown in FIGS. 3-4, in the first embodiment, limiting protrusions 13 are defined on the second lap joints 9, and the limiting protrusions 13 extend downward and are clamped to the female housing 8. Grooves, matched with the limiting protrusions 13, are disposed on the female housing 8, and the limiting protrusions 13 are clamped on the grooves to assist in positioning and clamping of the second lap joints 9 relative to the female housing 8. In addition, as shown in FIG. 3, in the first embodiment, first clamping teeth 12 protruding outward are disposed on two sides of each of the first lap joints 6. The first clamping teeth 12 assist the first lap joints 6 to be clamped in the male housing 7.

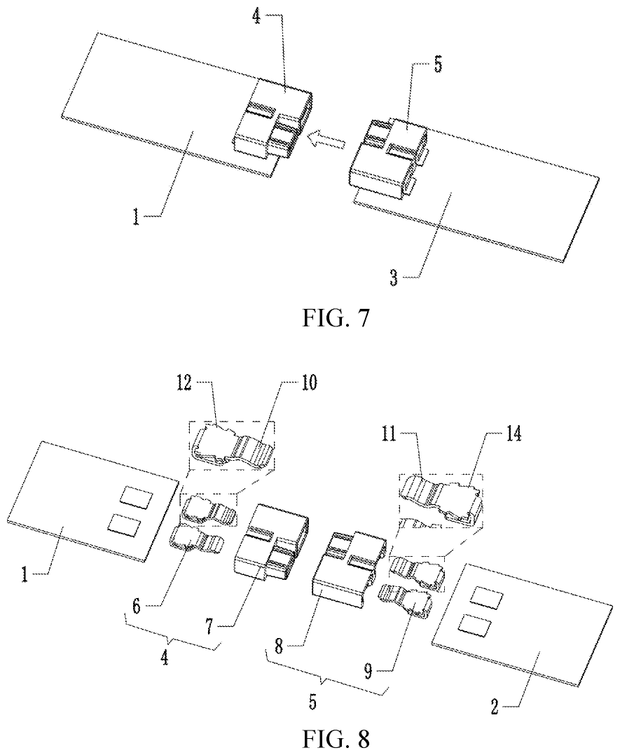

A second embodiment (as shown in FIGS. 6-10):

As shown in FIGS. 6-8, in the second embodiment, the first lap joints 6 are soldered to the first PCB 1, and the second lap joints 9 are soldered to the second PCB 3. Second clamping teeth 14 protruding outward are disposed on two sides of each of the second lap joints 9. The second clamping teeth 14 assist the second lap joints 9 to be clamped in the female housing 8. Meanwhile, in the second embodiment, the first lap joints 6 and the second lap joints 9 are same assemblies. In addition, in the second embodiment, other parts of the male end 4 and the female end 5 are the same as those of the first embodiment, and details are not described herein again.

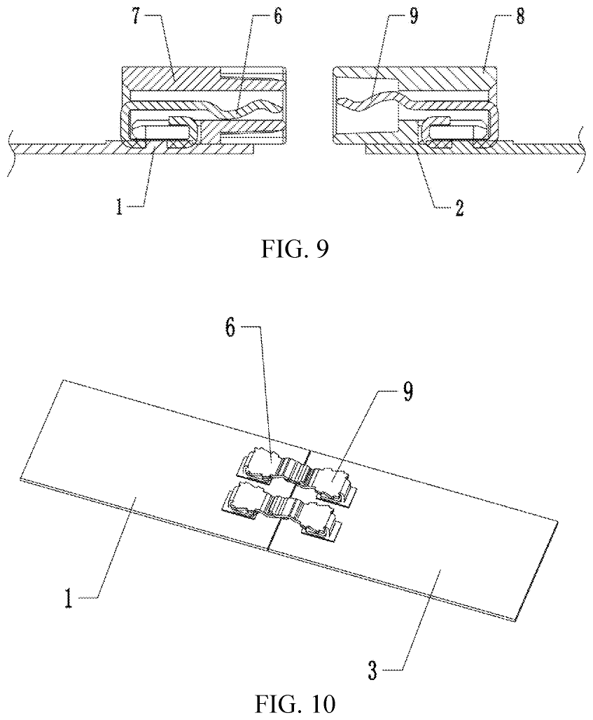

As shown in FIGS. 9-10, in the second embodiment, the male end 4 further includes the pair of the first lap joints 6 where one of the first lap joints 6 is directly disposed on the male housing 7 and another one of the first lap joints 6 is inverted on the male housing 7, and the female end 5 further includes the pair of the second lap joints 9 where one of the second lap joints 9 is directly disposed on the female housing 8 and another one of the second lap joints 9 is inverted on the female housing 8. Since the first lap joints 6 and the second lap joints 9 are same assemblies, types of parts are reduced, which is convenient for management and production.

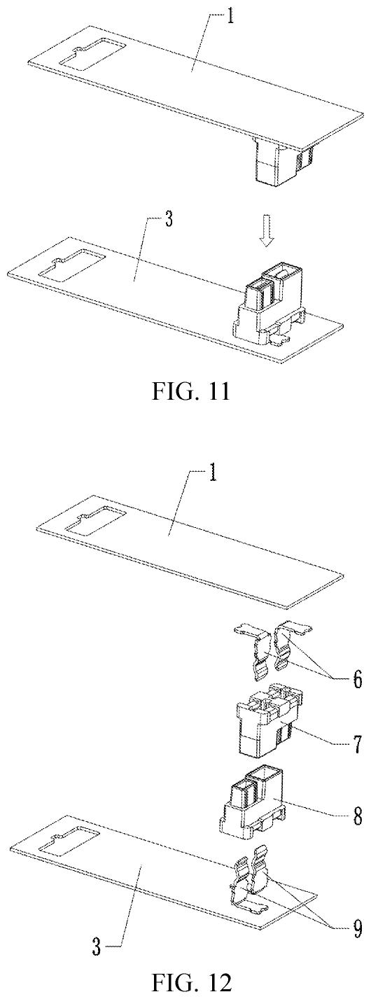

A third embodiment (as shown in FIGS. 11-12):

As shown in FIGS. 11-12, in the third embodiment, the first lap joints 6 are soldered to the first PCB 1, and the second lap joints 9 are soldered to the second PCB 3. The first lap joints 6 and the second lap joints 9 are respectively perpendicularly soldered to the first PCB 1 and the second PCB 3.

In the third embodiment, the first lap joint portions 10 of the first lap joints 6 and the second lap joint portions 11 of the second lap joints 9 are the same as the first lap joint portions 10 and the second lap joint portions 11 of the first embodiment, and details are not described herein again. In the third embodiment, the first lap joints 6 and the second lap joints 9 are all L-shaped, one end of each of the first lap joints 6 and one end of each of the second lap joints 9 are soldered on front surfaces of the PCBs, and another end of each of the first lap joints 6 and another end of each of the second lap joints 9 are disposed on a male housing 7 or a female housing 8.

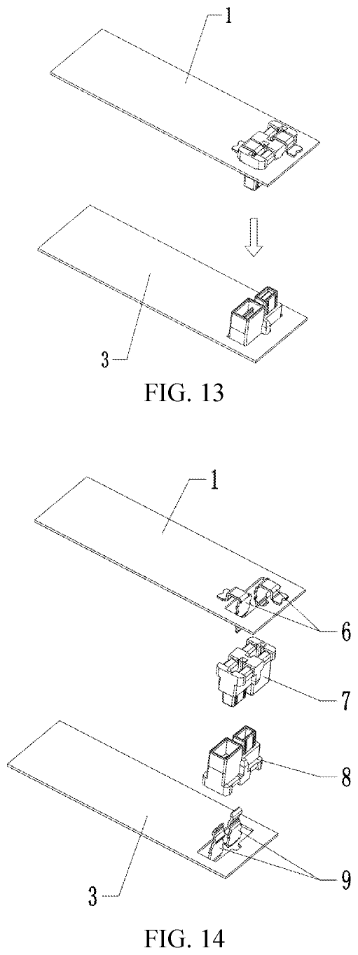

A fourth embodiment (FIGS. 13-14):

As shown in FIGS. 13-14, being same as the third embodiment, in the fourth embodiment, the first lap joints 6 are soldered to the first PCB 1, and the second lap joints 9 are soldered to the second PCB 3. The first lap joints 6 and the second lap joints 9 are respectively perpendicularly soldered to the first PCB 1 and the second PCB 3. According to the connector of the fourth embodiment, compared with the third embodiment, the first lap joints 6 and the second lap joints 9 respectively penetrate through the first PCB 1 and the second PCB 3, and the first lap joints 6 and the second lap joints 9 are soldered to back surfaces of the PCBs.

Through the above embodiments, the male end 4 and the female end 5 of the connector of the present disclosure may be made in a thin flat shape. In addition, the wave-shaped first lap joint portions 10 and the wave-shaped second lap joint portions 11 are attached together through staggered squeezing and lap joints, which not only allows the first lap joint portions 10 and the second lap joint portions 11 to be tightly attached to achieve electrical connection, but also allows the first lap joint portions 10 and the second lap joint portions 11 to be in surface-to-surface contact. Compared with the prior art, the present disclosure greatly increases a contact area between the male end 4 and the female end 5, and reduces the heat generated when the current passes through, so as to meet the passage of the high current. Meanwhile, when the wave-shaped first lap joint portions 10 and the wave-shaped second lap joint portions 11 are in lap joint fit with each other, the locking function is achieved, and the connection stability of the male end 4 and the female end 5 is enhanced.

The above description is only the preferred embodiments of the present disclosure and is not intended to limit the present disclosure. For the person skilled in the art, the present disclosure may have various modifications and variations. Any modifications, equivalent replacements, improvements and the like made within spirit and principle of the present disclosure shall fall within the protection scope of the present disclosure.

What is claimed is:

1. A connector, configured to electrically connect a first printed circuit board (PCB) (1) with a second PCB (3), or configured to electrically connect the first PCB (1) with conductive wires (2), comprising:
a male end (4); and
a female end (5);
wherein the male end (4) comprises a male housing (7) and a pair of first lap joints (6); the first lap joints (6) are disposed on the male housing (7) and are soldered to the first PCB (1); a pair of first lap joint portions (10), extending forward and having elasticity, are disposed on the first lap joints (6); the first lap joint portions (10) are in a geometry shape of wave-shaped thin plate;
the female end (5) comprises a female housing (8) and a pair of second lap joints (9); wherein the female housing (8) is matched with the male housing (7); the second lap joints (9) are disposed on the female housing (8), the second lap joints (9) are soldered to the second PCB (3) or electrically connected to the conductive wires (2); a pair of second lap joint portions (11), extending forward and having elasticity, are disposed on the second lap joints (9); the second lap joint portions (11) are in a geometry shape of wave-shaped thin plate; and the second lap joint portions (11) are matched with the first lap joint portions (10); and
the male housing (7) is disposed on the female housing (8), and the male housing (7) drives the first lap joint portions (10) to be overlapped and attached to the second lap joint portions (11), so that the first PCB (1) is electrically connected to the second PCB (3) or the conductive wires (2).

2. The connector according to claim 1, wherein the first lap joint portions (10) and the second lap joint portions (11) are both in a geometry shape of S-shaped thin plate, and ends of the first lap joint portions (10) face opposite to ends of the second lap joint portions (11).

3. The connector according to claim 1, wherein the male end (4) comprises the pair of the first lap joints (6) where one of the first lap joints (6) is directly disposed on the male housing (7) and another one of the first lap joints (6) is inverted on the male housing (7); and the female end (5) comprises the pair of the second lap joints (9) where one of the second lap joints (9) is directly disposed on the female housing (8) and another one of the second lap joints (9) is inverted on the female housing (8).

4. The connector according to claim 1, wherein the conductive wires (2) are detachably plugged into the second lap joints (9).

5. The connector according to claim 4, wherein limiting protrusions (13) are disposed on the second lap joints (9), and the limiting protrusions (13) extend downward and are clamped to the female housing (8).

6. The connector according to claim 1, wherein the second lap joints (9) are soldered to the second PCB (3), and the first lap joints (6) and the second lap joints (9) are same assemblies.

7. The connector according to claim 1, wherein first clamping teeth protruding outward are disposed on two sides of each of the first lap joints (6).

8. The connector according to claim 1, wherein the second lap joints (9) are soldered to the second PCB (3), and both the first lap joints (6) and the second lap joints (9) are horizontally or vertically disposed on the first PCB (1) and the second PCB (3).
